(19) United States
(12) Patent Application Publication
(10) Pub. No.: US 2018/0056417 A1
(43) Pub. Date: Mar. 1, 2018

(54) METHOD FOR MACHINING THE TOOTH FLANKS OF FACE COUPLING WORKPIECES IN THE SEMI-COMPLETING METHOD

(71) Applicant: Klingelnberg AG, Zurich (CH)

(72) Inventor: Wilhelm Kreh, Radevormwald (DE)

(21) Appl. No.: 15/684,878

(22) Filed: Aug. 23, 2017

(30) Foreign Application Priority Data
Aug. 23, 2016 (EP) 16185240.5

(51) Int. Cl. B23F 15/06; B23F 19/00

(52) U.S. Cl. CPC B23F 15/06; B23F 19/005

(57) ABSTRACT

A continuous semi-completing method for machining the tooth flanks of a face coupling workpiece using a gear cutting tool having multiple blades. Exemplary methods include a) setting of a first machine setting, wherein an inner cutting edge of an mth blade of the gear cutting tool machines a convex flank of a first tooth gap, and an inner cutting edge of a further blade machines a convex flank of a following tooth gap, until all convex flanks of all tooth gaps are finish machined, and b) setting of a second machine setting wherein an outer cutting edge of an nth blade of the gear cutting tool machines a concave flank of a tooth gap, and an outer cutting edge of a further blade machines a concave flank of a following tooth gap, until all concave flanks of all tooth gaps are finish machined.

### CROSS REFERENCE TO RELATED APPLICATIONS

This application claims priority under 35 U.S.C. §§119(a)-(d) to European patent application no. EP16185240.5 filed Aug. 23, 2016, which is hereby expressly incorporated by reference as part of the present disclosure.

### FIELD OF INVENTION

The subject matter of the invention is a method for machining the gear teeth of face couplings, wherein it is specifically a semi-completing method.

### BACKGROUND

Face couplings are machine elements which have a cone angle which is 90°. The face couplings are also referred to as spur gear couplings. Face couplings are used, for example, in power plants, on the axles of vehicles, and also, for example, on the camshafts thereof. They are also used in wind turbines. Face couplings can be used as permanent couplings, which are distinguished by a fixed, friction-locked connection of two coupling elements (also called coupling halves). The two coupling halves can be screwed together with one another or connected in another manner in this case. However, face couplings can also be used as disconnectable couplings (called shift couplings).

A face coupling is not a gear drive, which comprises gearwheels which roll on one another. Therefore, completely different conditions than in gear drives apply both in the production and also during use of face coupling. Thus, the coupling elements of a face coupling cannot be produced by rolling methods. It is also important to know that the coupling elements of a face coupling produced according to the method according to the invention do not have a constant tooth head height in the flank longitudinal direction, which is a result of the manufacturing.

The teeth of the face couplings are to have a high precision and are to enable a maximum load transmission, i.e., a high carrying capacity. The teeth of face coupling have a curved (spiral-shaped) tooth profile, i.e., the flank longitudinal lines are curved. Upon pairing of two coupling elements, all concave tooth flanks of a first coupling element are engaged simultaneously with all convex tooth flanks of the second coupling element. For this purpose, one left-spiral coupling half is paired with one right-spiral coupling half in each case.

Face couplings can be produced in various ways, as described hereafter. A differentiation is made between face couplings which were produced according to the Klingelnberg cyclo-palloid method and according to the Oerlikon method. In addition, there are face couplings which are referred to as Curvic® couplings (Gleason, USA).

The cyclo-palloid method is a continuous method. The teeth of face couplings which were produced according to the cyclo-palloid method have a variable tooth height. In the cyclo-palloid method, two cutter heads are used, which are mounted eccentrically one inside another. Not all machines are capable of accommodating two cutter heads in the manner mentioned. The blades which are used in the cyclo-palloid method are assembled into groups and are arranged on a short section of a multithread spiral on the cutter head. While the cutter heads and the workpiece rotate continuously during the cyclo-palloid method, each new blade group respectively passes through a subsequent tooth gap of the workpiece to be machined. Separate blades are associated with the convex and the concave tooth flanks of the face couplings in the cyclo-palloid method. However, these separate blades are arranged on the same rotation circle radius, if one neglects a small correction value which is necessary to produce a longitudinal crowning.

The cutter heads which are used in the scope of the Oerlikon method as tools have a complex construction.

In the Curvic® coupling method, the radius of the tool, the number of teeth of the face coupling, and the diameter of the face coupling are dependent on one another. In the Curvic® coupling method, two tooth gaps are always cut simultaneously. Subsequently, the teeth are ground. It is a significant disadvantage of the Curvic® couplings that they necessarily have to have an even number of teeth. In addition, the teeth of the Curvic® couplings have a constant tooth height.

### SUMMARY

In the industrial production of face coupling, it is important to find simple and rapid methods, because these factors have an influence on the cost-effectiveness.

The object thus presents itself of providing a method for the industrial production of face coupling, which offers more degrees of freedom and is more flexibly usable. In addition, the method is to be more cost-effective than previously known methods.

According to some embodiments, a method is a continuous semi-completing method, a gear cutting tool is used which comprises multiple blades, which each have an inner cutting edge and an outer cutting edge, and the method comprises the following steps a) and b), which are carried out in the machining sequence a) and b) or in the machining sequence b) and a):
a) setting of a first machine setting and rotational driving of the face coupling workpiece about a workpiece rotation axis and coupled rotational driving of the gear cutting tool about a tool rotational axis, wherein an indexing movement of the face coupling workpiece with the gear cutting tool results due to the coupled rotational driving of the face coupling workpiece with the gear cutting tool, and wherein the first machine setting is defined and the coupled rotational driving is performed so that an inner cutting edge of an mth blade of the gear cutting tool machines a convex flank of a first tooth gap of the face coupling workpiece and an inner cutting edge of a further blade, which follows after the mth blade, machines a convex flank of a following tooth gap of the face coupling workpiece, until all convex flanks of all tooth gaps are completely machined, and
b) setting of a second machine setting and rotational driving of the face coupling workpiece about the workpiece rotational axis and coupled rotational driving of the gear cutting tool about the tool rotational axis, wherein an indexing movement of the face coupling workpiece with the gear cutting tool results due to the coupled rotational driving of the face coupling workpiece with the gear cutting tool, and wherein the second machine setting is defined and the coupled rotational driving is performed so that an outer cutting edge of an nth blade of the gear cutting tool machines a concave flank of a tooth gap of the face coupling workpiece, and an outer cutting edge of a further blade, which follows after the nth blade, machines a concave flank of a following tooth gap of the face coupling workpiece, until all concave flanks of all tooth gaps are completely machined.

The steps a) and b) of the method of at least some embodiments of the invention can be carried out in the machining sequence a) and b) or in the machining sequence b) and a), as already noted.

The machining sequence can also be changed if needed, for example, to ensure more uniform wear on the gear cutting tool.

To achieve more uniform wear of the outer cutting edges and the inner cutting edges of the blades of the gear cutting tool, in at least some embodiments, one of the following machining sequences can be used during the machining of two face coupling workpieces: a), b), b) a); or b), a), a), b).

The method of at least some embodiments of the invention may be used in a previously untoothed workpiece. In this case, the outer cutting edges and the inner cutting edges cut into solid material, as soon the gear cutting tool executes a broaching movement paired with the coupled rotational movements.

In the case of the machining sequence a) and b), during the machining of the convex flanks using the inner cutting edges (also referred to as finishing), the concave flanks of the face coupling workpiece are roughed (also referred to as pre-machining) using the outer cutting edges. During the roughing, the outer cutting edges are used as secondary cutting edges.

In the case of the machining sequence b) and a), during the machining of the concave flanks using the outer cutting edges (also referred to as finishing), the convex flanks of the face coupling workpiece are roughed in the inner cutting edges (also referred to as pre-machining). During the roughing, the inner cutting edges are used as secondary cutting edges.

According to at least some embodiments of the invention, the adjustment of the machine setting may be performed after the gear cutting tool exits from the face coupling workpiece. In this case, there is sufficient space for the adjustment of the machine setting—for example, from a first machine setting to a second machine setting (or vice versa)—and collisions of the gear cutting tool with the face coupling workpiece cannot occur. It is an advantage of this approach that more degrees of freedom are available for the relative movements which are carried out during the adjustment of the machine setting than in the case of an approach in which the adjustment of the machine setting occurs in the broached state. It is a further advantage of the adjustment of the machine setting outside the face coupling workpiece that in principle only the parameters of the two machine settings have to be specified to the machine controller. The specific execution of the relative movements can be left to the machine controller in this case and the machine controller can execute the relative movements on the basis of its standard programming. In contrast, if the adjustment of the machine setting is to occur while engaged with the face coupling workpiece, precise specifications (for example, by specifying multiple path points) should be made for the machine setting to execute the relative movements, in order to avoid collisions.

For the mentioned reasons, the method of at least some embodiments of the invention therefore may follow the following scheme in the case of the machining sequence a) and b): in step a), the rotationally-driven gear cutting tool broaches into the material of the face coupling workpiece, after the first machine setting has been set, at the end of step a), the gear cutting tool exits from the face coupling workpiece, and in step b), the rotationally-driven gear cutting tool broaches into the material of the face coupling workpiece, after the second machine setting has been set.

For the mentioned reasons, the method of at least some embodiments of the invention therefore may follow the following scheme in the case of the machining sequence b) and a): in step b) the rotationally driven gear cutting tool broaches into the material of the face coupling workpiece, after the second machine setting has been set, at the end of step b), the gear cutting tool exits from the face coupling workpiece, and in step a), the rotationally-driven gear cutting tool broaches into the material of the face coupling workpiece, after the first machine setting has been set.

In those embodiments having the machining sequence a) and b), after step a) and before step b), the first machine setting is transferred into the second machine setting, wherein this transfer may be performed after the gear cutting tool has been retracted from the face coupling workpiece.

In those embodiments having the machining sequence b) and a), after step b) and before step a), the second machine setting is transferred into the first machine setting, wherein this transfer may be performed after the gear cutting tool has been retracted from the face coupling workpiece.

In at least some embodiments, the rotational movements of the gear cutting tool about the tool rotational axis and of the face coupling workpiece about the workpiece rotational axis are coupled to one another. This coupling of the two rotational movements is referred to here as coupled rotational driving. The coupled rotational driving may be performed so that in each case only one blade of the gear cutting tool moves through a tooth gap and, for example, the next blade moves through the next gap. The coupling of the two rotational movements can be performed mechanically and/or the coupling can be specified electronically by a CNC controller of the machine (called electronic coupling).

In at least some embodiments, due to the coupled rotational driving of the face coupling workpiece with the gear cutting tool, a (relative) indexing movement of the face coupling workpiece with the gear cutting tool results. This indexing movement has the result that in a part of the embodiments, an inner cutting edge of a cutting head (finish) machines a convex tooth flank in a chip-removing manner, while an outer cutting edge of the cutting head (pre-) machines a concave tooth flank of the same tooth gap in a chip-removing manner. Then, the convex tooth flank of a following tooth gap is (finish) machined in a chip-removing manner using an inner cutting edge of another cutting head, while the outer cutting edge of this other cutting head (pre-) machines a concave tooth flank of this tooth gap in a chip-removing manner.

Because, in the continuous semi-completing method of at least some embodiments of the invention, one inner cutting edge and one outer cutting edge are each seated on a common cutting head or blade, radius differences are automatically forced in the index plane of the face coupling workpiece. These radius differences have heretofore been influenced by the following angle between the inner cutting edge and outer cutting edge in the case of solutions which use separate inner cutting edges and outer cutting edges. A longitudinal crowning on the convex and concave tooth flanks may occur due to the mentioned radius differences. According to some embodiments of the invention, this longitudinal crowning can be adapted by a suitable selection of the tool inclination (called tilt) in relation to the face coupling workpiece, to thus obtain the desired longitudinal crowning.

The radius difference and therefore also the longitudinal crowning is typically excessively large due to the combination of the inner cutting edges and outer cutting edges on common cutting heads. To reduce the longitudinal crowning, a reduced tool inclination may therefore be used in these cases. The tool may be pivoted away in relation to the face coupling workpiece due to the reduction of the tool inclination. This pivoting away has the result that less base angle correction is required, i.e., the machine base angle can be somewhat less in this case.

Embodiments are also possible in which the inclination can be specified so that the machine base angle can be zero. This special case can occur if the tool is inclined sufficiently far away in relation to the face coupling workpiece.

If the tool inclination has to be increased, the tool may thus be pivoted in relation to the face coupling workpiece. However, this pivoting in has the result that a greater base angle correction is required.

It is an advantage of at least some embodiments of the invention that, because of the fact that the concave and convex tooth flanks are machined separately, spiral angle errors can be corrected (e.g., reduced) by an adaptation of the machine settings. In addition, the longitudinal crowning may be adapted optimally to the desired values by the adaptation of the machine settings.

Therefore, it is considered to be an advantage of at least some embodiments of the invention that the method is more flexible than the previous methods. The method of at least some embodiments of the invention offers, for example, multiple degrees of freedom with regard to the adaptation/optimization of the topography of the concave and convex flanks.

Moreover, the gear cutting tool of at least some embodiments of the invention is simpler than the known two-part systems (such as, for example, the cyclo-palloid method). In addition, the gear cutting tool is usable more universally, since it has a consistent sequence of the cutting heads or the blades, respectively. It is a further advantage that due to the combination of inner cutting edges and outer cutting edges in one cutting head in each case, or in a blade, respectively, there is more space on the circumference of the tool for accommodating further cutting heads or blades, respectively. This means that the number of threads can be increased without problems, which corresponds to an increase of the productivity.

This is a so-called continuous semi-completing method here, as already noted. In this case, this is a special continuous method, which is used according to the invention for milling the gear teeth of face coupling workpieces. The two opposing flanks of a tooth gap of the face coupling workpiece to be machined are machined using the same tool but using different machine settings.

The (gear cutting) tool is equipped according to at least some embodiments of the invention with only one blade type, wherein an inner cutting edge and an outer cutting edge are arranged on each blade (also called a cutting head here). The inner cutting edge and the outer cutting edge of each blade are therefore in a permanently predefined relationship to one another because of the design. It is an advantage of this configuration that the position of the inner cutting edge in relation to the outer cutting edge on the blade is invariable. Such blades, which have or bear both cutting edges on a blade body, are significantly simpler to install and adjust in a cutter head than, for example, the different blades which are used in the Curvic coupling method.

The continuous semi-completing method of at least some embodiments of the invention can be used with a single cut strategy, since the face coupling workpieces have a small tooth height (compared to bevel gear workpieces). Because of the small tooth height, only relatively little material has to be removed per tooth flank in a face coupling workpiece. Therefore, a tooth gap can be finish machined using only one broaching movement in a first machine setting and only one broaching movement in a second machine setting.

The semi-completing method of at least some embodiments of the invention has the advantage that face couplings can be produced by this method, which have a higher flexibility in the matter of the number of teeth than the Curvic® couplings mentioned at the outset.

The semi-completing method of at least some embodiments of the invention also has the advantage that corrections (for example, to produce a crowning) are defined by the first and/or second machine setting. The crowning can be influenced, for example, by changing the inclination angle (also called a “tilt angle” herein).

The semi-completing method of at least some embodiments of the invention also has the advantage that multiple different workpieces can be machined using a standardized tool, depending on the equipping with suitable blades.

It is a further advantage of at least some embodiments of the invention that in contrast to the prior art, no following angle problem results, as explained hereafter on the basis of a reference to previously known methods. The Oerlikon method mentioned at the outset, because of the completing approach, does not offer any possibility to compensate for the spiral angle errors due to two separate cutter head center points for convex and concave tooth flanks. Therefore, in the Oerlikon method, the natural sequence of the blades is changed, which simultaneously produces a longitudinal crowning of the tooth flanks. This has the result that special cutter heads have to be used. In the Klingelnberg cyclo-palloid method, which was also already mentioned, the two cutter head center points are implemented by a two-part cutter head gearing in the machine tool.

It is a further advantage of at least some embodiments of the invention that the flanks of the face couplings may be optimized substantially independently of one another, because they are machined separately.

The continuous semi-completing method of at least some embodiments of the invention has the advantage that it can be used on (conventional) bevel gear machines.

The continuous semi-completing method of at least some embodiments of the invention has the advantage that tools can be used which are simpler than in the cyclo-palloid, Oerlikon, and Curvic coupling methods mentioned at the outset.

### DRAWINGS

An exemplary embodiment of the invention is described in greater detail hereafter with reference to the drawings.

FIG. 1A shows a top view of a first face coupling according to the invention, wherein only four teeth and three tooth gaps are shown (the four teeth are emphasized in FIG. 1A by a pattern);

FIG. 1B shows an axial section through the first face coupling according to FIG. 1A;

FIG. 1C shows the index plane of the tool through the design point, wherein the index plane of the tool is inclined in relation to the index plane of the workpiece by the machine base angle κ;

FIG. 1D shows an enlarged portion of FIG. 1C, wherein this portion contains further details;

FIG. 1E shows a perspective view of a single tooth gap of a face coupling;

FIG. 2 shows a top view of a gear cutting tool, wherein only two cutting heads of the gear cutting tool are shown;

FIG. 3A shows a perspective view of an exemplary stick blade, which can be used in a gear cutting tool;

FIG. 3B shows an enlarged, very schematic portion of the blade tip of the stick blade of FIG. 3A, to be able to illustrate the positive tip width on the basis of this example.

### DETAILED DESCRIPTION OF EMBODIMENTS

Terms are used in conjunction with the present description which are also used in relevant publications and patents. However, it is to be noted that the use of these terms is only to serve for better comprehension. The inventive concepts are not to be limited by the specific selection of the terms. At least some embodiments of the invention may be readily transferred to other term systems and/or technical fields. The terms are to be applied accordingly in other technical fields.

Gear cutting tools 100 having defined cutting edges are used in the scope of the various embodiments of the present invention. Primarily details of embodiments in which cutter head gear cutting tools are used are described in conjunction with the following description. However, the description can also be expanded to solid tools.

The reference sign 10 is used here both for the face coupling workpiece and also for the finish machined face coupling elements.

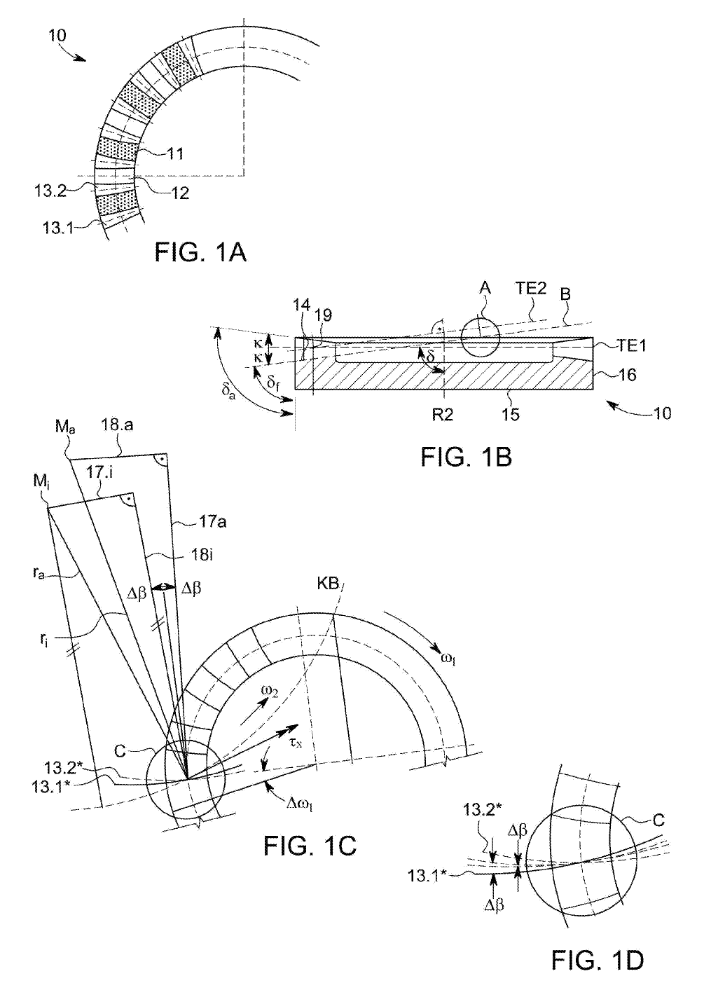

FIG. 1A shows a top view of a portion of a first face coupling workpiece 10. The teeth 11 are provided with a pattern to visually emphasize them. Four teeth 11 and three tooth gaps 12 can be seen. FIG. 1B shows an axial section through the first face coupling workpiece 10. In FIG. 1A, short dashed curve sections show the flank lines of the concave flanks 13.2 and the convex flanks 13.1 in the index plane TE1 of the face coupling workpiece 10, wherein one concave flank 13.2 together with one convex flank 13.1 defines each tooth 11. The tool rotational movement is identified in FIG. 1C with ω₂ and the workpiece rotational movement is identified with ω₁. The gear cutting tool 100 is not shown in FIGS. 1A-1E. However, the movements of the gear cutting tool 100 are shown here.

Since the method of at least some embodiments of the invention is a continuous semi-completing method, the face coupling workpiece 10 and the gear cutting tool 100 are rotationally driven in a coupled manner. In FIG. 1C, only a portion of a circular arc is shown in the form of a dashed line of the gear cutting tool 100, which is defined by the tool radius rᵢ and is provided here with the reference sign KB. The tool radius rᵢ is associated with the inner cutting edges 21.i of the gear cutting tool 100, which are used for machining the convex tooth flanks 13.1, and the tool radius rₐ is associated with the inner cutting edges 21.a of the gear cutting tool 100, which are used for machining the concave tooth flanks 13.2.

Variables which are identified here with a v each relate to the concave flanks 13.2 of the face coupling workpiece 10. Variables which are identified here with an x each relate to the convex flanks 13.1 of the face coupling workpiece 10. Additionally, variables which are identified here with an i relate to inner cutting edges or inner grinding surfaces and variables which are identified here with an a relate to outer cutting edges or outer grinding surfaces.

It is to be noted here that FIG. 1C shows the special case without tool inclination (i.e., here τ=0). The path KB of the gear cutting tool 100 is therefore a circle in the index plane TE1 through the design point 19 (see FIG. 1B) and the base path B of the blade tips is a straight line in FIG. 1B. With a tool inclination (i.e., with τ≠0), the path KB becomes an ellipse and the base path B of the blade tips also becomes an ellipse. The gear cutting tool 100 is inclined by the angle T about the rotation vector, which is perpendicular to the tool radius.

The rotation center for machining the convex tooth flanks 13.1 is identified as Mᵢ and for machining the concave tooth flanks 13.2 is identified as Mₐ (see FIG. 1C). It can already be seen from the fact that there are two different rotation centers Mᵢ and Mₐ that the convex tooth flanks 13.1 are machined using a different machine setting than concave tooth flanks 13.2.

Because of the fact that in the gear cutting tool 100 of at least some embodiments of the invention, one outer cutting edge 21.a and one inner cutting edge 21.i were combined on cutting head 22, different tool radii rₐ>rᵢ result. In addition, the spiral angle difference Δβ, which results between the index plane TE2 of the tool and the index plane TE1 of the workpiece (see FIG. 1D) as a result of the base angle correction κ (if κ≠0), has to be compensated for (see FIG. 1C). Therefore, a different machine setting of the machine has to be used during the cutting of the concave flanks 13.2 than during the cutting of the convex flanks 13.1. Thus, during the cutting of the convex flanks 13.1 in the index plane TE2 of the tool, an epicycloid flight path 13.1* of the inner cutting edge 21.i results. The epicycloid flank lines are shown by dot-dash lines in FIG. 1A and FIG. 1E. The epicycloids in the tool index plane of the convex flanks are shown in bold in FIGS. 1C and 1E and deviate from the flank lines of the index plane TE1 of the workpiece by the spiral angle difference Δβ.

During the cutting of the concave flanks 13.2, because of a different machine setting in the index plane TE2 of the tool, an epicycloid flight path 13.2* of the outer cutting edge 21.a results. The epicycloid flank lines are shown by dot-dash lines in FIG. 1A and FIG. 1E. The epicycloids in the tool index plane of the concave flanks 13.2 are shown by dashed lines in FIGS. 1C and 1E and deviate from the flank lines of the index plane TE1 of the workpiece by the spiral angle difference Δβ.

It is to be noted here that the illustration of FIGS. 1A, 1C, 1D, and 1E is schematic. The course of the flight paths shown is illustrated exaggerated.

The relative location of the gear cutting tool 100 in relation to the face coupling workpiece 10 is defined by the respective instantaneous setting of the machine (hereinafter called “machine setting”), in which the face coupling workpiece 10 is machined by milling. This setting during the machining of the convex flanks 13.1 is called the first machine setting here. The setting during the machining of the concave flanks 13.2 is called the second machine setting here.

The names “first machine setting” and “second machine setting” are not to specify a sequence here, but rather these names are merely used to be able to differentiate the two machine settings.

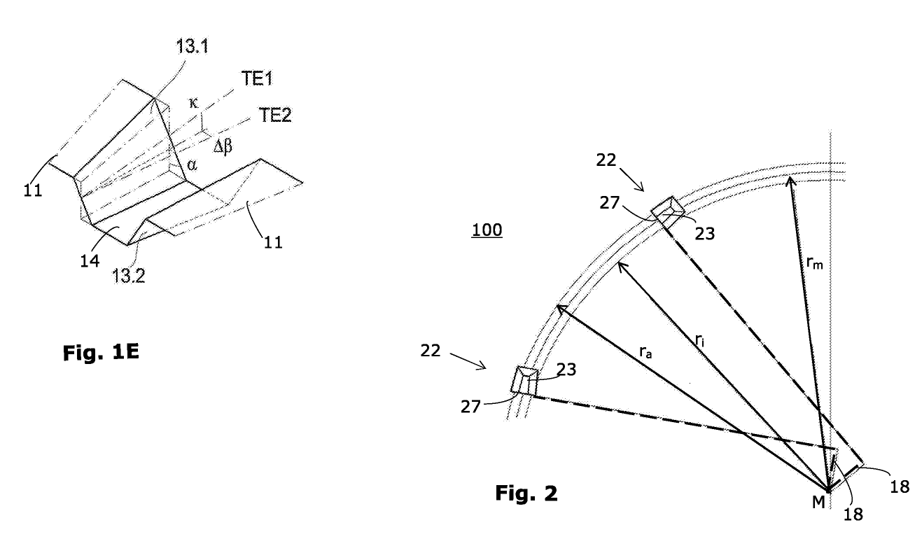

In the coordinate system of the tool 100, the cutting heads 22, or the blades 20, move along circular circles of rotation, the radius of which is determined by the distance of the blades 20 from the tool rotational axis R1. Details can be inferred from FIG. 2, where two cutting heads 22, or blades 20, respectively, of a gear cutting tool 100 and the rotation center M of the gear cutting tool 100 are shown in a top view. The tool radius of the inner cutting edges is also identified here with rᵢ and the tool radius of the outer cutting edges with rₐ, as already mentioned. The blade tips 23 of all cutting heads 22 are seated on a common rotation circle, the radius of which is identified with rₘ.

Since the tool 100 is inclined during the machining of the concave and convex flanks in relation to the face coupling workpiece 10 (by inclining away or inclining toward, defined by the angle of inclination τ), the cutting heads 22 move along elliptical flight paths during the rotational driving ω₂ of the gear cutting tool 100, if one observes the movement thereof from the position of the face coupling workpiece 10. Because of the indexing movement (caused by the coupled rotation) of the face coupling workpiece 10 with the gear cutting tool 100, flanks result on the face coupling workpiece 10 which have the shape of an epicycloid, as already noted. In the method of at least some embodiments of the invention, the two rotational movements ω₁ and ω₂ are coupled so that only one cutting head 22 moves through a tooth gap 12 at a time. The next cutting head 22 of the gear cutting tool 100 moves through the next tooth gap 12 of the face coupling workpiece 10. In order that the chip angle of the rake surface 27 of the cutting heads 22 approximately corresponds to 0° during the cutting of the material of the face coupling workpiece 10, the cutting heads 22 are arranged with an offset on the gear cutting tool 100. This offset is shown in FIG. 2 by the two dashed line trains 18. The corresponding offset lines are identified with 18.i and 18.a in FIG. 1C.

The rotation center M of the face coupling workpiece 10 corresponds to the passage point of the tool rotational axis R1 through the plane of the drawing of FIG. 2. It is to be noted that the gear cutting tool 100 can be inclined in both machine settings, to thus specify an inclined path B (see FIG. 1B), as described hereafter. This inclination is defined here by the machine base angle κ.

According to at least some embodiments of the invention, in the first machine setting, for example, all convex tooth flanks 13.1 of the tooth gaps 12 of the (not previously toothed) face coupling workpiece 10 are finish machined. This finish machining of the convex tooth flanks 13.1 is performed using the inner cutting edges 21.i of the tool 100. While the inner cutting edge 21.i of one cutting head 22 finish machines a convex tooth flank 13.1, the outer cutting edge 21.a of the same cutting head 22 carries out a pre-machining (also called roughing) of the concave tooth flank 13.2 of the same tooth gap 12. In the second machine setting, for example, all concave tooth flanks 13.2 of the tooth gaps 12 of the (not previously toothed) face coupling workpiece 10 are then finish machined.

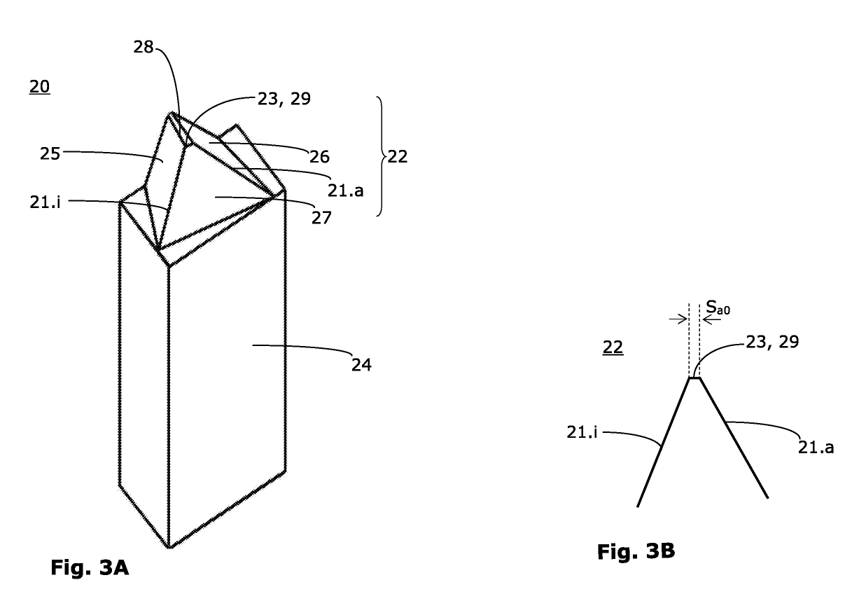

It is to be noted that the dimensions of the cutting head 22 (especially the location of the inner cutting edge 21.i and the outer cutting edge 21.a, and also the tip width sₐ₀, as schematically shown in FIG. 3B on the basis of an example) and the machine kinematics are specified so that the outer cutting edge 21.a does not cut excessively far into the material of the face coupling workpiece 10 during the pre-machining of the concave tooth flank 13.2, because the final flank shape is first finish machined using the second machine setting.

The first machine setting may include, according to at least some embodiments of the invention, for example, the following criteria or features: (1) in the first machine setting, all inner cutting edges 21.i are moved in relation to the face coupling workpiece 10 along a first elliptical flight path and all outer cutting edges 21.a are moved in relation to the face coupling workpiece 10 along a second elliptical flight path. In FIG. 1C, all blades move around the center Mᵢ on a circle. (2) The first elliptical flight path is concentric to the second elliptical flight path, i.e., the first elliptical flight path spans a common plane together with the second elliptical flight path; and (3) An epicycloid tooth flank results on those tooth flanks which are machined in the first machine setting, due to the coupled rotational movements of the tool 100 and the workpiece 10.

According to at least some embodiments of the invention, a second machine setting is set in the machine to finish machine the concave tooth flanks 13.2.

The second machine setting differs from the first machine setting and it may include, according to at least some embodiments of the invention, for example, the following criteria or features: (1) in the second machine setting, all outer cutting edges 21.a are moved in relation to the face coupling workpiece 10 along a third elliptical flight path. In FIG. 1C, all blades move around the center Mₐ on a circle. (2) the third elliptical flight path has an effective radius which is greater than the effective radius of the second elliptical flight path; (3) As long as the tool inclination τ during the machining of the convex and concave flanks is equal, the plane which is spanned by the third elliptical flight path is a plane which extends in parallel to the common plane spanned by the first elliptical flight path and the second elliptical flight path. Without tool inclination τ (i.e., if τ=0), these planes are identical; and (4) For optimization purposes, the tool inclination τₓ of the convex flank and τᵥ of the concave flank can be different in all embodiments.

As already indicated, the cutting heads 22, or the blades 20, of the gear cutting tool 100 may be guided in at least some embodiments along an inclined path B (see FIG. 1B) through the tooth gaps 12 of the face coupling workpieces 10. This aspect is to be taken into consideration in the specification of the first and the second machine settings.

If one wishes to achieve a constant tooth head play, it is advantageous to operate with the same profile of the inclined path B during the finish gear cutting of the concave flanks and during the finish gear cutting of the convex flanks. For optimization purposes, however, the inclined path B can have a slightly different profile during the finish gear cutting of the concave flanks than during the finish gear cutting of the convex flanks.

The face coupling 10 of at least some embodiments of the invention may include the following features. In all embodiments, it has an index cone angle δ, which is 90°. In FIG. 1B, the index plane TE1 is illustrated by a dot-dash line which extends perpendicularly to the workpiece rotational axis R2.

The face coupling 10 of at least some embodiments of the invention may include the following features: a) it has teeth 11 having variable tooth head height, as can be seen in FIGS. 1B and 1E; b) the teeth 11 are conical in the tooth height direction, as can be seen in FIG. 1B; c) the tooth gaps 12 have a base plane, or a tooth base 14, which is inclined, as can be seen in FIGS. 1B and 1E. The inclination of the tooth base 14 results because if needed a corrected machine base angle κ can be set in the method of at least some embodiments of the invention so that the cutting heads 22 or the blades 20, respectively, of the gear cutting tool 100 are guided along an inclined path B (as already noted) through the tooth gaps 12 of the face coupling 10. This inclined path B is diagonal to the index plane TE1 in an axial section of the face coupling 10 (see FIG. 1B). The base cone angle δ_{f} at the tooth base 14 is δ_{f}=δ−κ here. The inclined path B, or the machine base angle κ, respectively, can be selected so that reverse cutting of the face coupling 10 due to continued running of cutting heads 22 or blades 20 is avoided. In FIG. 1B, it can be seen in region A that the blade tips 23 are guided along the inclined path B through the three-dimensional space until the blade tips 23 only remove material of the face coupling workpiece 10 in the region of the tooth gaps presently to be machined.

The further details of the face coupling 10 of FIGS. 1A to 1E are not characteristic of the invention and are therefore only to be understood as examples. The face coupling 10 shown has, for example, a rear installation surface 15, which can be completely flat. No transition surface is provided in this example at the heel between the lateral surface 16 and the installation surface 15, which is sometimes routine. The lateral surface 16 thus merges at a right angle into the installation surface 15 here. The head cone angle δₐ is greater than 90° in the example shown and the base cone angle δ_{f} is less than 90°. The tooth height decreases continuously from the heel to the toe (i.e., from the outside to the inside). However, there are also embodiments of the invention in which the head cone angle δₐ is equal to 90° (not shown here, however).

According to at least some embodiments of the invention, an end milling cutter head is used as the cutter head gear cutting tool 100 in all embodiments. The end milling cutter head is equipped with multiple stick blades 20, which protrude on the end face from the gear cutting tool 100. A stick blade 20 preferably has a shape as shown as an example in FIG. 3A in all embodiments. The stick blade 20 has a shaft 24. The shape of the shaft 24 is selected so that the stick blade 20 can be fastened securely and accurately in a corresponding blade groove or chamber of the cutter head gear cutting tool 100. The cross section of the shaft 24 can be rectangular or polygonal, for example.

In the head region (identified here as the cutting head 22) of the stick blade 20, a first open surface 25, a second open surface 26, a (common) rake surface 27, a head open surface 28, an inner cutting edge 21.i, an outer cutting edge 21.a, and a head cutting edge 29 are located, for example.

The rake surface 27 intersects with the first open surface 25 in a virtual intersection line, which approximately corresponds to the profile of the inner cutting edge 21.i, or which exactly corresponds to the profile of the inner cutting edge 21.i. The rake surface 27 intersects with the second open surface 26 in a virtual intersection line which approximately corresponds to the profile of the outer cutting edge 21.a, or which exactly corresponds to the profile of the outer cutting edge 21.a.

However, the rake surface 27 does not have to be a flat surface, as shown in FIG. 3A on the basis of a simplified illustration.

The cutting heads 22, or the blades 20, respectively, are arranged in all embodiments with an offset in relation to the rotation center M, such that the rake surfaces 27 have a rake angle of zero in relation to the epicycloid. According to FIG. 1C, the inner cutting edges 21.i are offset by 18.i from the dashed line according to the line 17i. The line 17i is perpendicular to the epicycloid. Therefore, the rake surface 27 is also perpendicular to the epicycloid. The rake angle thus becomes 0°.

Since one inner cutting edge 21.i and one outer cutting edge 21.a are each located on a common cutting head 22 (or blade 20, respectively), the rake angle=0° is to be ensured by the mentioned offset.

The present invention, as already noted, is a continuous semi-completing method. The opposing flanks 13.1, 13.2 of the face coupling workpiece 10 to be machined are machined using the same tool 100, but using different machine settings. Before, during, or after the adjustment of the machine setting from the first to the second or from the second to the first machine setting, in all embodiments, for example, a retraction movement and an infeed movement (broaching movement) can be executed.

Preferably, the adjustment of the machine setting is performed in all embodiments only after the tool 100 has been moved out of the tooth gaps 12.

The method of at least some embodiments of the invention can be executed, for example, on a bevel gear cutting machine, wherein the face coupling workpiece 10 is fastened on the workpiece spindle and the tool 100 is fastened on the spindle of the bevel gear cutting machine. There are numerous different gear cutting machines (for example, 5-axis and 6-axis gear cutting machines), in which the method of the invention can be carried out.

A suitable gear cutting machine is designed so that it specifies the mentioned coupled relative movements precisely using the tool 100 and the face coupling workpiece 10 in the engagement of the tool 100 with the face coupling workpiece 10.

Typical variables which can define a specific machine setting in this environment are the location of the rotation center M in relation to the location of the face coupling workpiece 10 (defined, inter alia, by the axis offset), the radial, the swivel angle, the machine base angle κ, the angle of inclination τ (tilt angle), the rotational position of the tool rotational axis R1, the roller swaying angle, and the depth position of the tool 100 in relation to the face coupling workpiece 10.

At least one of the mentioned typical variables is changed upon the transition from the first to the second machine setting.

The description above can also be applied to solid tools having fixed blades and not only to bar cutter heads.

As may be recognized by those of ordinary skill in the pertinent art based on the teachings herein, numerous changes and modifications may be made to the above described and other embodiments of the present invention without departing from the spirit of the invention as defined in the claims. Accordingly, this detailed description of embodiments is to be taken in an illustrative, as opposed to a limiting sense.

What is claimed is:

1. A method for machining tooth flanks of a face coupling workpiece in a continuous semi-completing process, the method comprising:
performing the following steps a) and b), which are carried out in a sequence of step a) and then step b), or a sequence of step b) and then step a), using a gear cutting tool having a plurality of blades, wherein each of the plurality of blades includes an inner cutting edge and an outer cutting edge, and steps a) and b) comprise:
a) setting a first machine setting, rotationally driving the face coupling workpiece about a workpiece rotational axis, and coupledly rotationally driving the gear cutting tool about a tool rotational axis, wherein the first machine setting is defined and said coupled driving of the face coupling workpiece with said driving of the gear cutting tool is performed to provide an indexing movement of the face coupling workpiece relative to the gear cutting tool, machine a convex flank of a first tooth gap of the face coupling workpiece with a respective inner cutting edge of an mth blade of the gear cutting tool, and machine a convex flank of a following tooth gap of the face coupling workpiece with an inner cutting edge of a further blade of the gear cutting tool that follows after the mth blade, until all convex flanks of all tooth gaps of the face coupling workpiece are finish machined;
b) setting a second machine setting, rotationally driving the face coupling workpiece about the workpiece rotational axis and coupledly rotationally driving the gear cutting tool about the tool rotational axis, wherein the second machine setting is defined and said coupled driving of the face coupling workpiece with said driving of the gear cutting tool is performed to provide an indexing movement of the face coupling workpiece relative to the gear cutting tool, machine a concave flank of a first tooth gap of the face coupling workpiece with a respective outer cutting edge of an nth blade of the gear cutting tool, and machine a concave flank of a following tooth gap of the face coupling workpiece with an outer cutting edge of a further blade of the gear cutting tool that follows after the nth blade, until all concave flanks of all tooth gaps of the face coupling workpiece are finish machined.

2. The method according to claim 1, wherein the face coupling workpiece was untoothed prior to performing the method, and the method further comprises:
when step a) and then step b) is performed, roughing the concave flanks of the face coupling workpiece with the outer cutting edges of the plurality of blades during said machining of the convex flanks using the inner cutting edges of the plurality of blades, or
when step b) then step a) is performed, roughing the convex flanks of the face coupling workpiece with the inner cutting edges of the plurality of blades during said machining of the concave flanks using the outer cutting edges of the plurality of blades.

3. The method according to claim 1, further comprising:
when step a) and then step b) is performed,
during step a), broaching the rotationally-driven gear cutting tool into the material of the face coupling workpiece after the first machine setting has been set,
at the end of step a), removing the gear cutting tool from the face coupling workpiece, and
during step b), broaching the rotationally-driven gear cutting tool into the material of the face coupling workpiece after the second machine setting has been set.

4. The method according to claim 1, further comprising:
when step b) then step a) is performed,
during step b), broaching the rotationally-driven gear cutting tool into the material of the face coupling workpiece after the second machine setting has been set,
at the end of step b), removing the gear cutting tool from the face coupling workpiece, and
during step a), broaching the rotationally-driven gear cutting tool into the material of the face coupling workpiece after the first machine setting has been set.

5. The method according to claim 1, further comprising, when step a) and then step b) is performed, after step a) and before step b), retracting the gear cutting tool from the face coupling workpiece, and transferring from the first machine setting into the second machine setting.

6. The method according to claim 1, further comprising, when step b) and then step a) is performed, after step b) and before step a), retracting the gear cutting tool from the face coupling workpiece, and transferring from the second machine setting into the first machine setting.

7. The method according to claim 1, wherein the inner cutting edge and the outer cutting edge of a respective blade are located on a common cutting head of the tool.

8. The method according to claim 1, wherein the plurality of blades are assembled into groups, and each group includes only one blade.

9. The method according to claim 1, wherein the second machine setting differs from the first machine setting by one or more of:
a location of a rotation center of the tool in relation to a location of the face coupling workpiece;
a setting of a radial of a machine in which the method is executed;
a setting of a sway angle of a machine in which the method is executed, or
a setting of a tilt angle of a machine in which the method is executed.

10. The method according to claim 1, wherein the tool is a cutter head gear cutting tool or a solid tool, each of the plurality of blades includes a cutting head including the inner cutting edge and the outer cutting edge, and the inner cutting edge and outer cutting edge are arranged on the cutting head to define a positive tip width.

11. The method according to claim 1, further including, in the first machine setting and in the second machine setting, inclining the tool in relation to the face coupling workpiece, and guiding the tool along an inclined path through the first tooth gap during machining thereof, wherein said inclined path, in an axial section through the face coupling workpiece, is generally parallel to a profile of a tooth base of the first tooth gap.

12. The method according to claim 11, wherein said tooth base of said tooth gap is inclined at a machine base angle in relation to an index plane of the face coupling workpiece.

13. The method according to claim 1, further comprising controlling a crowning of teeth of the face coupling workpiece by setting an inclination of the tool in relation to the face coupling workpiece.

14. The method according to claim 1, further comprising compensating for spiral angle errors of the face coupling workpiece by changing one or more of the first or second machine setting.
